(19) United States
(12) Patent Application Publication
(10) Pub. No.: US 2013/0346301 A1
(43) Pub. Date: Dec. 26, 2013

(54) SYSTEMS AND METHODS FOR BILLING VIA A SYMBOLOGY

(71) Applicants: Andre Gustavo Vellozo Luz, Sao Paulo-SP (BR); Mauricio Ghetler, Sao Paulo-SP (BR)

(72) Inventors: Andre Gustavo Vellozo Luz, Sao Paulo-SP (BR); Mauricio Ghetler, Sao Paulo-SP (BR)

(73) Assignee: PAYCHIEF LLC., New York, NY (US)

(21) Appl. No.: 13/531,367

(22) Filed: Jun. 22, 2012

(51) Int. Cl. G06Q 20/14

(52) U.S. Cl. 705/40

(57) ABSTRACT

Methods and systems for bill payment are disclosed. Billing information may be received from a payee. Data corresponding to the billing information may be generated and provided to the payee. The payee may create a symbology encoding the data for delivery to the payor. Data corresponding to a payment authorization encoded by the symbology may be received from a mobile device. Funds from a first account may be transferred to a second account as a result.

### BACKGROUND

Recently, the use of mobile devices, such as smartphones and the like, has rapidly increased. This increase has resulted in part from the porting of technologies to mobile electronic devices that were once limited to non-mobile applications. Mobile technologies provide the promise of a more efficient use of time by allowing interactions with other people and institutions at any time and place. One particular mobile technology demand of consumers is an increased ability to securely manage one's financial situation, such as, for example, transferring funds and other monetary instruments.

Current mobile device technology and the financial services infrastructure to support the technology continues to provide more convenient, secure, and rapid attention to one's financial needs in the mobile environment. However, further development in this field remains necessary to provide rapid transmission of funds between users, which further allows for an instant or almost instant availability of transferred funds. Accordingly, there exists a need for additional secure, easy-to-use systems and methods for transferring funds.

### SUMMARY

In an embodiment, a method of offering a payment option for a payment of bills may include (1) receiving, by a computing device, a payment request for a bill having information for receiving payment from a payee; (2) creating, by the computing device, data corresponding to the payment request; and (3) transmitting, by the computing device, the data to the payee, who creates a symbology encoding the data for delivery to a payor.

In an embodiment, a method of offering a payment option for a payment of bills may include (1) receiving, by an electronic device, a payment request for a bill having information for receiving the payment from a payee; (2) transmitting, by the electronic device, the payment request to a computing device; (3) receiving, by the electronic device, data corresponding to the payment request from the computing device; (4) creating, by the electronic device, a symbology encoding the data therein; and (5) transmitting, by the electronic device, the symbology to a payor.

In an embodiment, a method of paying a bill may include (1) receiving, by a mobile device, data associated with a bill payment request encoded by a symbology; and (2) transmitting, by the mobile device, the data to a computing device, which automatically transfers funds from a first account to a second account according to the bill payment request.

In an embodiment, a method of bill payment may include (1) receiving, by a computing device, billing information from a payee; (2) generating, by the computing device, data corresponding to the billing information; (3) providing, by the computing device, the data to the payee, who generates a symbology for delivery to the payor; (4) receiving, by the computing device, data corresponding to a payment authorization encoded by the symbology from a mobile device; and (5) transferring funds, by the computing device, from a first account to a second account.

In an embodiment, a system for bill payment may have a processing device and a non-transitory, processor-readable storage medium in communication with the processing device. The non-transitory, processor-readable storage medium may contain one or more programming instructions that, when executed, cause the processing device to (1) submit billing information to a computing device; (2) receive data corresponding to the billing information from the computing device; (3) generate a symbology encoding the data therein; (4) provide the symbology to a payor; and (5) receive a payment confirmation from the computing device. The payment confirmation may include a verification that funds have been transferred by the computing device from a first account to a second account due to scanning, by a mobile device, the symbology to obtain the data and automatically submitting, by the mobile device, the data to the remote computing device.

### BRIEF DESCRIPTION OF THE DRAWINGS

FIG. 1 depicts a perspective view of a first and second face of a mobile device according to an embodiment.

FIG. 2 depicts a perspective view of a third face of the mobile device in FIG. 1 according to an embodiment.

FIG. 3 depicts a symbology according to an embodiment.

FIG. 4 depicts a block diagram of an illustrative communications system between mobile devices and a computing device according to an embodiment.

FIG. 5 depicts a block diagram of illustrative internal hardware that may be used to contain or implement program instructions according to an embodiment.

FIG. 6 depicts a flow diagram of an illustrative process for sending and receiving funds according to an embodiment.

FIG. 7 depicts a flow diagram of an illustrative process for creating a symbology in accordance with an embodiment.

FIG. 8 depicts a flow diagram of an illustrative process for receiving a symbology input and transferring funds according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “electronic device” refers to a device that includes a processing device and tangible, computer-readable memory. The memory may contain programming instructions that, when executed by the processing device, cause the device to perform one or more operations according to the programming instructions. Examples of electronic devices include personal computers, gaming systems, televisions and mobile devices.

A “mobile device” refers to an electronic device that is generally portable in size and nature. Accordingly, a user may transport a mobile device with relative ease. Examples of mobile devices include pagers, cellular phones, feature phones, smartphones, personal digital assistants (PDAs), cameras, tablet computers, phone-tablet hybrid devices, laptop computers, netbooks, ultrabooks, global positioning satellite (GPS) navigation devices, in-dash automotive components, media players, watches and the like.

A “computing device” is an electronic device, such as, for example, a computer, a server or components thereof. The computing device can be maintained by entities such as financial institutions, corporations, governments, and/or the like. The computing device may generally contain a memory or other storage device for housing programming instructions, data or information regarding a plurality of users, such as, for example, contact information, personal information, account information, account balances, account numbers and service login information. The computing device may also have data regarding product inventories, billing information, purchase order information, contracts, bills of sale, and/or the like. The data may optionally be contained on a database, which is stored in the memory or other storage device. The data may optionally be secured by any method now known or later developed for securing data. The computing device may further be in operable communication with one or more electronic devices, such as, for example, the mobile devices described herein. The communication between the computing device and each of the mobile devices may further be secured by any method now known or later developed for securing transmissions or other forms of communication. The computing device may further contain a registry of “authorized users” wherein the authorized users are users that have registered to use the systems and methods described herein. Users may obtain “authorized user” status by, for example, providing contact information, account information, and/or the like.

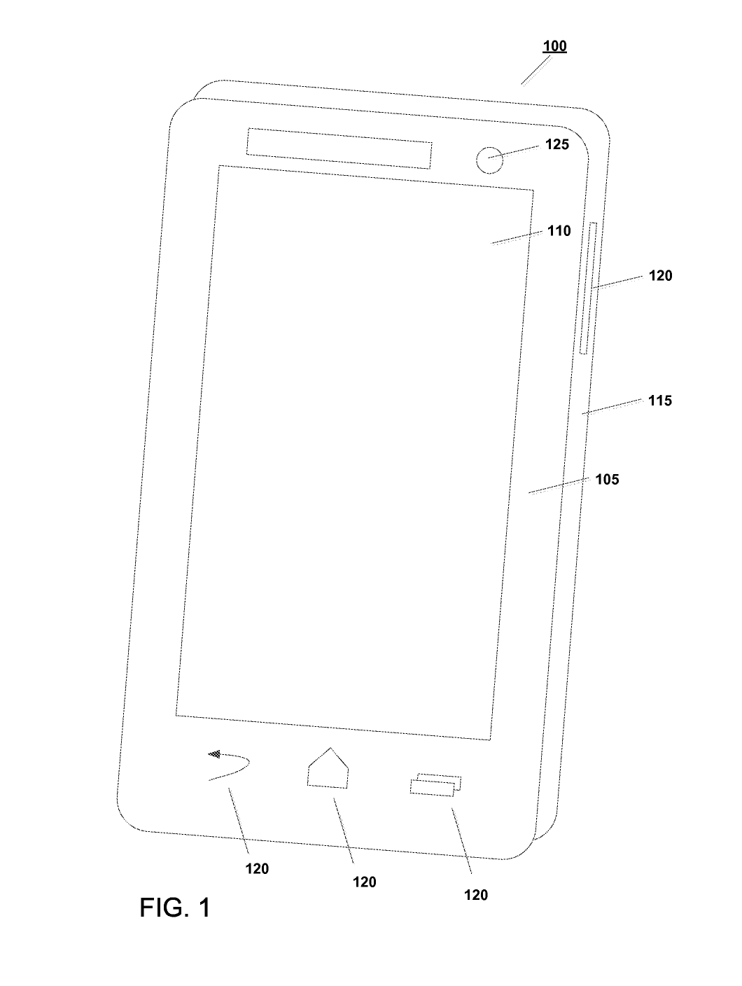

A “symbology” is a pattern, a symbol, an image or the like, as well as portions and combinations thereof, that is displayed on a substrate, such as, for example, the display depicted in FIG. 1. The symbology provides an optical, electronically-readable encoded representation of data. Symbologies can include, without limitation, one-dimensional barcodes, two-dimensional (2D) barcodes or three-dimensional barcodes. Examples of two-dimensional barcodes include data matrix codes, quick response codes, Aztec codes, Maxi codes and the like. Symbologies can also include letters, numbers, punctuation and other symbols. The symbology may be displayed on a display and may be of any geometric shape or size. In this document, the terms “barcode” or “matrix code” may be used in the examples, but the term is intended to include any type of symbology.

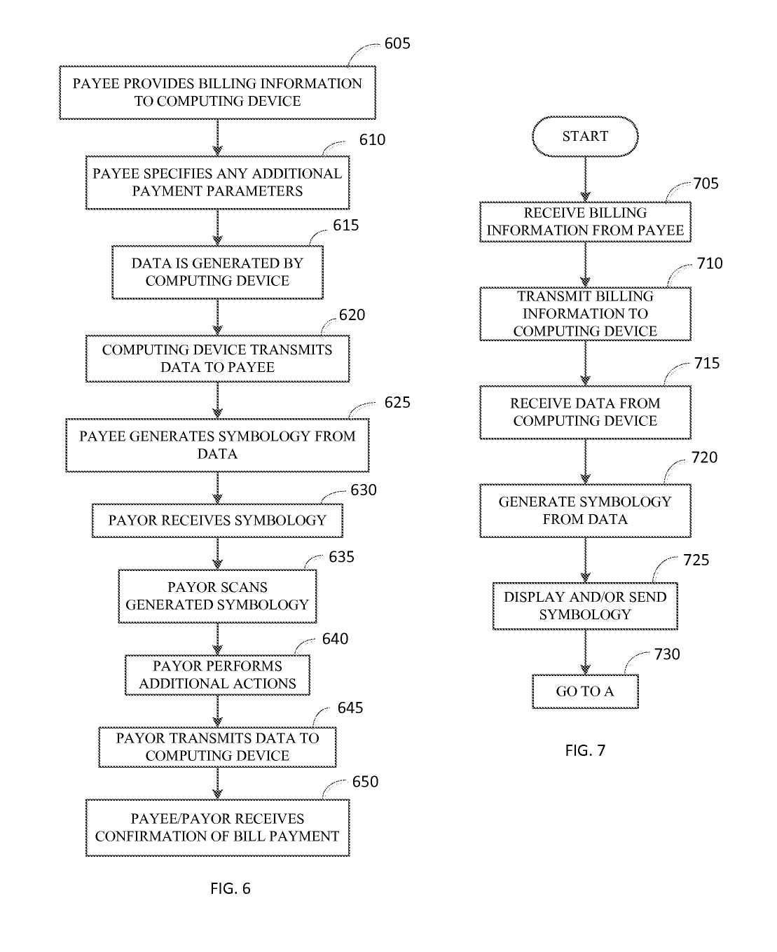

An “application environment” is an embodiment of programming instructions that direct the various components of each electronic device to execute a plurality of steps, such as those described in more detail in FIGS. 6, 7 and 8. The application environment, when contained in a mobile device, may be referred to as a “mobile application environment.” Similarly, the application environment, when contained in a computing device, may be referred to as a “computing application environment.” The mobile application environment may be a software application or the like, such as a smartphone “app.” The mobile application environment may generally provide a means for reading, decoding, encoding and communicating the data encoded by a symbology. The computing application environment may generally provide a means for communicating with each mobile device, a means for reading, translating and transmitting data, and a means for completing other tasks, as described in greater detail herein.

A “payee” is a user that sends a symbology and receives a bill payment in accordance with an embodiment. The payee can be an individual, a corporation, a financial services provider, a government or any other entity. Conversely, a “payor” is a user, such as a person or an entity, that receives a symbology from the payee and sends a bill payment in accordance with an embodiment. While this disclosure relates generally to a single payee and a single payor, those skilled in the art will recognize that multiple payees and payors may be involved in a transaction without departing from the scope of this disclosure.

Both the payee and the payor must be authorized users to use the application environment, and both must have an account that is recognized as one that is capable of disbursing and/or receiving funds, as described in more detail herein. Examples of accounts are not limited by this disclosure and may include, for example, savings accounts, checking accounts, money market accounts, brokerage accounts, credit accounts, certificates of deposit, electronic wallet accounts and/or pooled accounts wherein funding for the pooled account is obtained from a combination of one or more of the accounts described herein. The accounts may be held with, for example, financial institutions, banks, credit bureaus, building societies, credit unions, trust companies, mortgage loan companies, insurance companies, pension funds, brokers, underwriters and investment funds. The accounts may further contain some form of identifier, such as, for example, an American Bankers Association (ABA) routing transit number (RTN), account numbers, or any other identifier that may be used for identifying a user and/or a user's account.

A “bill” is a commercial document, such as an invoice, demanding payment for the purchase of goods, provision of services and/or the like. The bill may provide detailed information regarding the payee, the payor, the goods and/or services, and may also provide payment terms. Examples of payment terms may include, but are not limited to, an amount billed, a minimum amount due, a total balance due, a past amount due, due dates, penalties to be assessed and interest rates.

FIG. 1 depicts a perspective view of a mobile device, generally designated 100, according to an embodiment. The mobile device may have a first face 105 and a second face 115. The first face 105 may have a display 110. The display 110 may generally be a component for displaying images, text, video and the like. Examples of displays may include, but are not limited to, electroluminescent displays, electronic paper displays, vacuum fluorescent displays, light emitting diode (LED) displays, cathode ray tube (CRT) displays, liquid crystal (LCD) displays, plasma display panels, digital light processing (DLP) displays, and organic light-emitting diode (OLED) displays.

The mobile device 100 may be configured to generate a symbology and/or display the generated symbology on the display 110, as described in more detail herein. The mobile device 100 may generate the symbology by using any methods now known or later developed for creating and encoding symbologies. Alternatively, the mobile device 100 may receive the symbology from another mobile device and/or a computing device.

The mobile device 100 may further have one or more user interface components 120, which may be positioned on any face of the device, including, but not limited to, the first face 105 and the second face 115. The one or more user interface components 120 may generally be configured to elicit one or more commands to the mobile device 100 when actuated. Examples of user interface components 120 may include keypads, switches, buttons and/or the like.

As an alternative to, or in conjunction with the one or more user interface components 120, the display 110 may further include a touch sensitive screen, wherein the touch sensitive screen may act as a user interface component. The touch sensitive screen may receive contact based inputs from a user, such as from a user's fingers. The touch sensitive screen may be adapted for gesture control, thus allowing for a user to tap, pinch, swipe or provide other similar gestures to elicit commands to the mobile device 100. The touch sensitive screen may further be capable of sending touch commands to the processing device. Examples of touch sensitive screens may include, but are not limited to, resistive touchscreens, capacitive touchscreens, infrared touchscreens and/or other technologies now known or later developed. The mobile device 100 may also be adapted to receive commands via body gestures, voice, audio signals, device movement and/or the like.

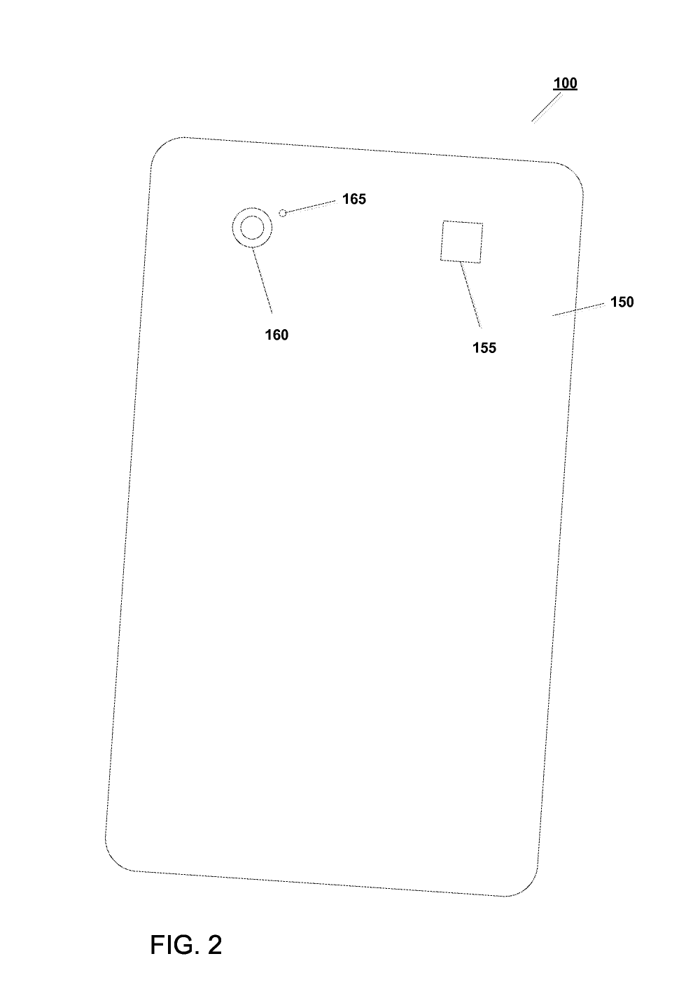

FIG. 2 depicts a perspective view of a third face 150 of the mobile device 100, according to an embodiment. The third face 150 may generally have an optical component 160. The third face 150 may also optionally have an audio component 155 and/or an illumination component 165.

The optical component 160 may be any suitable component capable of receiving an optical image and transmitting image information to other components of the mobile device 100 for processing, such as, for example, a camera. The optical component 160 may further have an ability to adjust its focal length and aperture in such a manner that would allow it to zoom and properly focus upon an intended object to be imaged. Such ability may be through mechanical components (such as an optical zoom) or programming (such as a digital zoom). This adjustment may define an “optimal focal distance,” or a range of distances in which the mobile device 100 may be properly positioned from the intended object to be imaged to achieve a clear image.

While the optical component 160 is depicted on the rear face of the present example, persons skilled in the art will appreciate that the optical component 160 may be positioned at any location on or in any face of the mobile device 100, or may even be external to the mobile device 100 and connected by any means of communication, including, but not limited to, physical cable communication such as universal serial bus (USB), wireless radio communication, wireless light communication, or near field communication technology.

The optical component 160 may further be configured to receive an optical image on the display of another mobile device, such as, for example, a symbology displayed on the display of the other mobile device, as described in greater detail herein.

The optional illumination component 165 may be utilized in any light conditions to assist the optical component 160 in completing any of the tasks described herein. Additionally, the illumination component 165 may be independently activated to turn on or off at specific points in time, such as when additional lighting is necessary to capture an ideal image. Other features of the illumination component 165 may include dimming, strobe, constant on and/or the like.

The illumination component 165 may contain any suitable light source capable of providing illumination, including, but not limited to, magnesium-based flashes, xenon-based flashes, fulminate-containing flashes, light-emitting diode (LED) flashes and the like. While the present figure depicts the illumination component 165 as being integrated with the mobile device 100, it may be appreciated that the illumination component 165 may be a separate component in communication with the mobile device 100, such as USB based flashes, hot shoe based flashes, remote slave flash units, or other similar devices.

The optional audio component 155 may be adapted to emit audio tones and signals. Such audio tones and signals may be used to instruct the user to complete various steps as described herein, and may further indicate to the user that an image has been received by the optical component 160 by emitting a beep, click or other audio signal. Additionally, the audio component 155 may be adapted to receive audio signals. Such audio signals may include, for example, voice commands from a user.

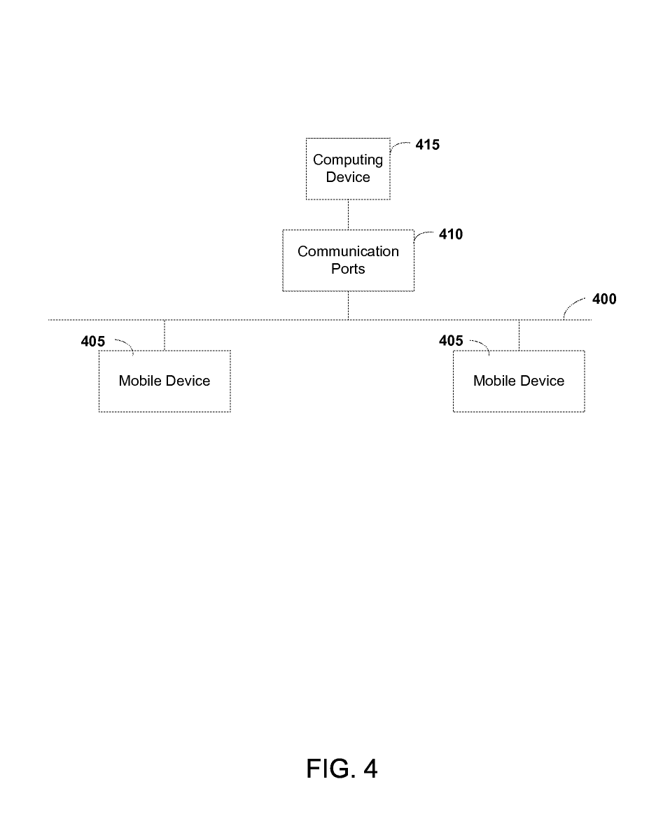

The mobile device 100 may further have an ability to connect to a communications network, as described in FIG. 4 herein. The types of communications networks that may be used in accordance with this disclosure are not limited in any manner, and may include any communications network now known or later developed. For example a communications networks may include, but is not limited to, the Internet, an intranet, a wide area network (WAN), a local area networks (LAN), a wireless local area networks (WLAN), a storage area networks (SAN) and/or the like.

The configuration of the mobile device 100 as shown in FIGS. 1 and 2 is merely an example of a mobile device, and persons skilled in the art will appreciate that other configurations and embodiments will be possible without departing from the scope of this disclosure.

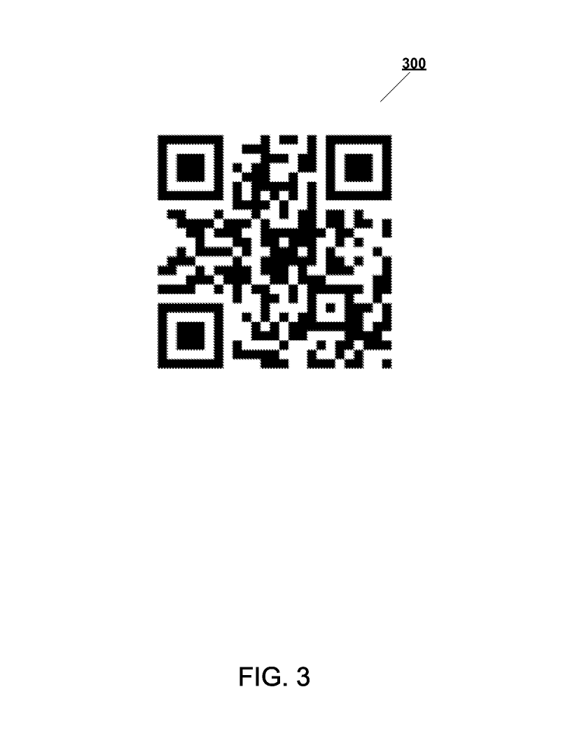

FIG. 3 depicts an example of a symbology, generally designated 300, that may be used in accordance with an embodiment. The symbology 300 may be displayed, for example, on the display 110 of the mobile device 100 (FIG. 1) or affixed to a substrate.

The symbology 300 may be generated by a mobile device 100, or may be generated by any other electronic device, such as for example, a computing device. In instances where the symbology 300 is generated by anything other than the mobile device 100, it may be transmitted to the mobile device 100 for further use, such as for display upon the display 110 (FIG. 1), addition to other documents and/or elements, or for scanning, reading or decoding.

The symbology 300 may be encoded with data that may generally be used by a computing device to gain access to secured information. Examples of secured information may include, but are not limited to, information regarding a user's banking account, an amount of money to be sent and/or received, a date and time of transmission of money for future payments, and/or the like. The symbology 300 may further be encoded with other data, such as, for example, information regarding a product or a service, information regarding a payee, purchase payment information, information about a bill and purchase order information.

The information encoded in the symbology 300 may further be encrypted. In instances where the information encoded in the symbology 300 is encrypted, the symbology 300 may only be read by certain symbology reading devices and/or applications, such as those that contain or maintain access to an encryption key or another similar means for decrypting the information encoded in the symbology 300. Encryption may be completed by any encryption method now known or later developed. Examples of encryption may include, but are not limited to, manual encryption, transparent encryption, symmetric encryption, asymmetric encryption and the like.

As an alternative to being encrypted, the symbology 300 may be readable by any symbology reading device and/or application. However, the information encoded within the symbology 300 may appear to a user of the symbology reading device and/or application as a random placement of characters, numbers, symbols and the like. However, if the symbology 300 is read using the application environment, the application environment may recognize the characters, numbers, symbols and the like and may perform or complete tasks accordingly, as described in more detail herein.

The symbology 300 may be a standalone image, or may be incorporated within another object, such as, for example, an additional image, text, icons and/or the like. In instances where the symbology 300 is incorporated within another object, the other object may provide at least a portion of the information encoded by the symbology 300.

FIG. 4 depicts a block diagram of communications between one or more electronic devices and one or more computing devices. A communications network 400 may serve as an information highway interconnecting the other illustrated components. The communications network is not limited by this disclosure, and may include any communications network now known or later developed. Examples of communications networks may include, but are not limited to, the Internet, intranets, wired networks and wireless networks. One or more electronic devices 405, such as mobile devices, computing devices and the like may connect to the communications network 400. In embodiments where a plurality of electronic devices 405 are connected to the communications network 400, each electronic device 405 may be configured to communicate with other electronic devices via the communications network 400. A computing device 415 may also be connected to the communications network 400, and may optionally connect through the use of one or more communications ports 410.

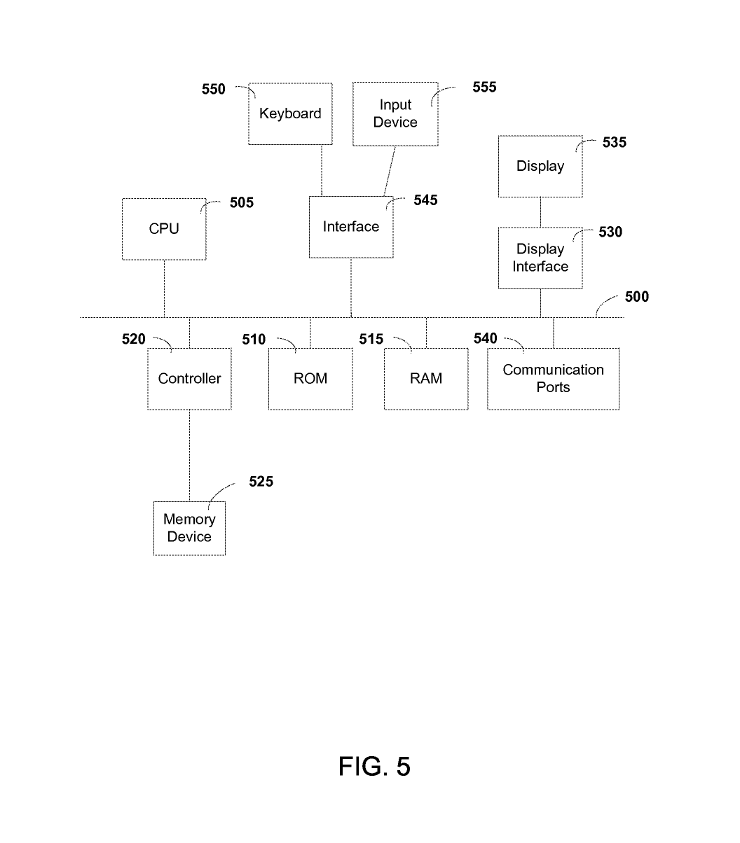

FIG. 5 depicts a block diagram of illustrative internal hardware that may be used to contain or implement program instructions, such as the process steps discussed herein in reference to FIGS. 6-8, according to embodiments. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an illustrative processing device, computing device or processor as such terms are used within this disclosure. Read only memory (ROM) 510 and random access memory (RAM) 515 constitute illustrative memory devices (i.e., processor-readable non-transitory storage media).

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 510 and/or the RAM 515. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 530 may permit information from the bus 500 to be displayed on the display 535 in audio, visual, graphic or alphanumeric format. Communication with external devices, such as a print device, may occur using various communication ports 540. An illustrative communication port 540 may be attached to a communications network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

FIG. 6 depicts a general bill payment process according to an embodiment. The process may involve a plurality of users, such as, for example, a payor and a payee. Each user may have an electronic device, as described herein. Each electronic device may have a processor and a memory containing programming instructions in the form of the application environment.

The payee may provide billing information to the computing device 605, which may include, for example, a payment request. The payment request may include an amount due by a given date according to the bill, as previously described herein. The payment request may further specify any type of funds, financial instruments or currency, as previously described herein. Examples of financial instruments may include, but are not limited to, securities, stocks, bonds, mutual funds, derivative contracts, commodities, and any other fungible, tradable asset. The payee may optionally specify additional payment parameters 610, such as, for example, a time the funds should be sent, limit options, expiration dates, automatically recurring payments, identification of the bill, the billing details and/or the like.

The application environment may record additional information about the electronic device at the time the payee enters the billing information 605. Examples of such additional information may include, but are not limited to, positional coordinates (e.g., GPS coordinates), a date and/or a time the billing information was entered, the type of electronic device used, user name and password information used to access the application environment, and/or the like. This information may be transmitted to the computing device for storage in the memory at the time the billing information is sent.

The computing device may store the billing information and the additional information in memory, and may a designate portion of the information stored in the memory as secured and only accessible by the computing device. Another portion may be designated as unsecured and accessible by other devices, such as, for example, one or more of the mobile devices. The secured portion may generally contain sensitive information, such as account numbers, account balances, sensitive personal information and the like. The unsecured portion may generally contain non-sensitive information, such as names, email addresses and the like. The computing device may use the received information to generate data that corresponds to the information 615. The data is not limited by this disclosure, and may contain, for example, a unique identifier that may only have a meaning with respect to the computing device.

Once the data has been generated, the computing device may transmit the data to the payee 620. The payee may generate a symbology encoding the data therein 625. In some alternative embodiments, the computing device may create the symbology encoding the data and transmit the symbology to the payee and/or the payor in lieu of the data. In particular embodiments, the computing device may affix the symbology to a bill before transmitting to the payee and/or the payor. The payor may receive the symbology 630, which may come directly from the computing device or from the payee, or the payor may retrieve the symbology from a webpage, a substrate, a bill and/or the like. Reception of the symbology may be by any means now known or later developed, such as, for example, receipt via email, receipt via short message service (SMS), receipt via multimedia messaging service (MMS), retrieving from a website, retrieving from a bill, retrieving from a bill and the like. Alternatively, the symbology may be affixed to another medium, such as by printing to a substrate, which may then be received by the payor.

Once the payor has received the generated symbology, he/she may generally display the symbology, such as on a substrate or on a display as disclosed herein, and may scan the symbology 635 to authorize payment. Scanning the symbology may be completed by any means now known or later developed for viewing, reading and/or decoding symbologies. In an embodiment, scanning may be completed through the use of any electronic device, such as, for example, the mobile device depicted in FIGS. 1 and 2. In addition to scanning, the payor may optionally complete any other additional tasks 640, such as, but not limited to, sending a message, setting payment terms, confirming payment, identifying products and/or services to be purchased, and/or the like. The mobile application environment may also record information about the mobile device at the time of scanning, such as, for example, positional coordinates (e.g., GPS coordinates), a date and/or a time the scanning took place, the type of mobile device used, user name and password information used to access the application environment, and/or the like.

Upon scanning, the data encoded by the symbology may be transmitted to the computing device 645 for funds transfer. Any other additional information entered by the payor and/or information recorded by the mobile application environment may also be transmitted to the computing device, along with the data encoded by the symbology. The payee and/or the payor may optionally receive a confirmation that the bill has been paid 655.

FIG. 7 depicts a process that may be carried out by an application environment in response to inputs received by a payee on an electronic device. The process may first involve receiving billing information from the payee 705. The billing information may be received via inputs in the form of a physical interaction with the electronic device containing the application environment, such as touching any number of user interface components, a touch screen and/or the like, as described herein. Alternatively or additionally, the inputs may be in the form of audio commands, gestures, physical movement of the electronic device and/or the like. The billing information may generally provide information to the application environment regarding the bill, such as, but not limited to, payee information and payor information, such as names, account numbers, addresses and telephone numbers, as previously described herein. The billing information may further include an amount to be transferred, whether it is a recurring payment, whether there is a limit price for the payment, whether there is an applicable time period during which the payment may be sent, whether there is an expiration date for sending payment and/or the like.

The application environment may transmit the billing information to the computing device 710, such as by using a secure means of communication, as described in greater detail herein. In addition, the application environment may transmit any additional information that was recorded at the time the inputs were received, as described in greater detail herein. The application environment may store the information received from the user inputs, as well as other information and the corresponding symbology, in a memory, such as a database. The memory may be located in the computing device and may only be accessible via the computing application environment through the use of secure means of communication, such as via encrypted communication. Alternatively or additionally, the memory may be in a remote location, such as a remote server, and may only be accessible via the computing application environment through the use of secure means of communication. The computing device may further generate data that corresponds to the stored information. The data may be, for example, a unique transaction code, as described in more detail herein.

Once the data has been generated, the application environment on the electronic device may receive the data from the computing device 715, and may generate a symbology from the data 720. Alternatively, the symbology may be generated by the computing device, transmitted to the electronic device in lieu of the data and/or affixed to the bill and transmitted to the payee and/or the payor, as described herein. Generation of the symbology may also involve encoding data that provides an indicator to the computing device to access transaction details.

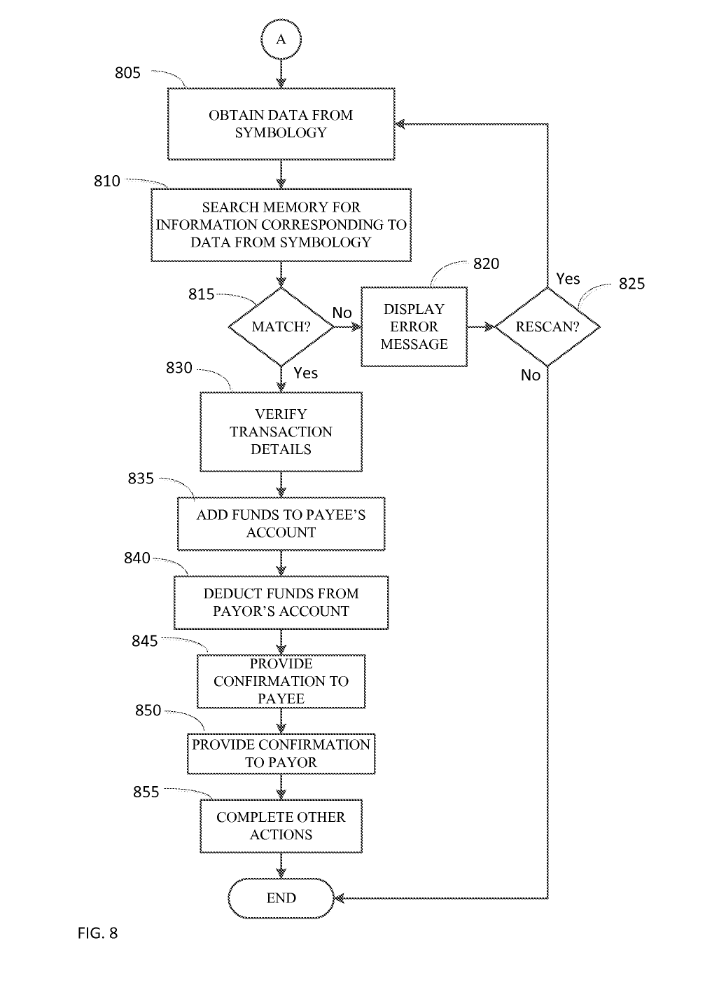

The symbology may optionally be displayed on the electronic device before it is sent to the payor, so as to present the payee with a number of options before sending to the payor 725. Examples of options for the payee may include, but are not limited to, reviewing the symbology before sending, providing a personal message to go with the symbology, printing the symbology, delaying the sending and affixing the symbology to a bill. Alternatively, the payee may never see the symbology; rather, it may be automatically sent to the payor. Once the symbology has been sent to the payor, the application environment on the payor's electronic device may be used to complete a series of steps 730 as depicted in FIG. 8.

FIG. 8 depicts a process that may be carried out by an application environment in response to inputs received by a payor on an electronic device. The payor may arrange an electronic device containing the application environment in such a manner so as to allow the application environment to obtain the data encoded in the symbology 805, such as by scanning. Scanning the symbology may be by any method of scanning, as discussed in greater detail herein. Obtaining the data may further require the application environment decrypt and/or decode the symbology. The data encrypted and/or encoded in the symbology may contain, for example, an identifier that, when provided to the computing device, acts as an authorization to transfer funds in accordance with the transaction details, as previously described herein.

The computing device may search the memory, such as a secure database stored on the secure computing device, for information corresponding to the decrypted/decoded identifier data from the symbology 810. A determination may be made as to whether a match exists between the identifier data from the symbology and the information in the database 815. If a match is not found, the application environment may notify the user of the error 820, and may prompt the user with an option to rescan the symbology 825. Lack of a match may be due to any number of reasons and is not limited by this disclosure. Examples of some reasons may include an improper scanning of the symbology, a symbology that is not intended for use in the methods and systems described herein, a symbology that was previously scanned, resulting in a transfer of funds and the like. If the user chooses to rescan the symbology, the process may repeat 805. If the user does not choose to rescan the symbology, the process may end.

If a match between the identifier and the information stored in the database exists, the application environment may optionally provide the payor with a confirmation of the transaction details 830 before the funds are transferred, so as to allow the payor to verify the terms of transfer. The application environment may automatically add funds to the payee's account 835 and at substantially the same time or a short time before or thereafter, deduct the same amount of funds from the payor's account 840. In addition to the funds transfer, the application environment may deduct any other amounts, such as transaction fees, or add any other amounts, such as rebates, from the payor's account, the payee's account, or both accounts.

The application environment may optionally provide a confirmation to the payee 845 and the payor 850. Confirmation may be in the form of a displayed message on the display of the electronic device, an email message, an audio alert, a haptic feedback alert, a telephone call, a mailed printout, a facsimile transmission and/or the like. Alternatively, or in addition, the payor and/or the payee may access a source, such as, for example, a website or a customer service phone number, to confirm that payment was sent and/or received.

The application environment may optionally complete one or more other actions 855. Examples of other actions may include, but are not limited to, automatically marking a bill as paid, confirming partial payment of a bill, confirming a full balance paid and/or the like.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of offering a payment option for a payment of bills, the method comprising:
receiving, by a computing device, a payment request for a bill from a payee, wherein the payment request comprises information for receiving the payment;
creating, by the computing device, data corresponding to the payment request; and
transmitting, by the computing device, the data to a payor, wherein the payor creates a symbology encoding the data for delivery to a payee.

2. The method of claim 1, wherein the data comprises a unique identifier that allows the computing device to match the symbology to the payment request.

3. The method of claim 1, wherein the payment request is stored as request data having a secured portion and an unsecured portion in a memory of the computing device.

4. The method of claim 3, wherein the secured portion of the request data is only accessible from the memory by the computing device.

5. The method of claim 1, wherein the symbology comprises one or more of a multi-dimensional bar code and a quick response (QR) code.

6. The method of claim 1, wherein the transmitting comprises affixing the symbology to a bill and delivering the bill to the payor.

7. The method of claim 1, wherein the information for receiving the payment comprises at least one of payor information, payee information, an amount billed, a minimum amount due, a total balance due, a past due amount, a due date, penalties to be assessed, and interest rates.

8. A method of offering a payment option for a payment of bills, the method comprising:
receiving, by an electronic device, a payment request for a bill from a payee, wherein the payment request comprises information for receiving the payment;
transmitting, by the electronic device, the payment request to a computing device;
receiving, by the electronic device, data corresponding to the payment request from the computing device;
creating, by the electronic device, a symbology encoding the data therein; and
transmitting, by the electronic device, the symbology to a payor.

9. The method of claim 8, wherein the data comprises a unique identifier that allows the computing device to match the symbology to the payment request.

10. The method of claim 8, wherein the payment request is stored as request data having a secured portion and an unsecured portion in a memory of the computing device.

11. The method of claim 3, wherein the secured portion of the request data is only accessible from the memory by the computing device.

12. The method of claim 8, wherein the symbology comprises one or more of a multi-dimensional bar code and a quick response (QR) code.

13. The method of claim 8, wherein the transmitting, by the electronic device, the symbology to the payor comprises affixing the symbology to a bill and delivering the bill to the payor.

14. The method of claim 8, wherein the information for receiving the payment comprises at least one of payor information, payee information, an amount billed, a minimum amount due, a total balance due, a past due amount, a due date, penalties to be assessed, and interest rates.

15. A method of paying a bill, the method comprising:
receiving, by a mobile device, data encoded by a symbology, wherein the data is associated with a bill payment request; and
transmitting, by the mobile device, the data to a computing device, wherein the computing device automatically transfers funds from a first account to a second account according to the bill payment request.

16. The method of claim 15, wherein the data comprises a unique identifier that directs the remote computing device to retrieve detailed payment information.

17. The method of claim 15, wherein the bill payment request comprises at least one of payor information, payee information, an amount billed, a minimum amount due, a total balance due, a past due amount, a due date, penalties to be assessed, and interest rates.

18. The method of claim 15, wherein the bill payment request is stored as request data having a secured portion and an unsecured portion in a memory of the computing device.

19. The method of claim 18, wherein the secured portion of the request data is only accessible from the memory by the computing device.

20. The method of claim 15, wherein the symbology comprises one or more of a multi-dimensional bar code and a quick response (QR) code.

21. A method of bill payment, comprising:
receiving, by a computing device, billing information for the payment of a bill from an electronic device;
generating, by the computing device, data corresponding to the billing information;
providing, by the computing device, the data to a payee, wherein the payee creates a symbology encoding the data for delivery to the payor;
receiving, by the computing device, the data encoded by the symbology from a mobile device, wherein the data corresponds to a bill payment authorization; and
transferring funds, by the computing device, from a first account to a second account according to the billing information.

22. The method of claim 21, further comprising:
providing a verification, by the computing device, that the funds have been transferred from the first account to the second account; and
marking the bill as paid.

23. The method of claim 22, wherein the verifying is conducted periodically.

24. The method of claim 21, wherein the billing information comprises at least one of payor information, payee information, an amount billed, a minimum amount due, a total balance due, a past due amount, a due date, penalties to be assessed, and interest rates.

25. The method of claim 21, wherein the symbology comprises one or more of a multi-dimensional bar code and a quick response (QR) code.

26. A system for bill payment, comprising:
a processing device; and
a non-transitory, processor-readable storage medium in communication with the processing device, wherein the non-transitory processor-readable storage medium contains one or more programming instructions that, when executed, cause the processing device to:
submit billing information to a computing device;
receive data from the computing device, wherein the data corresponds to the billing information;
generate a symbology encoding the data therein;
provide the symbology to a payor; and
receive a payment confirmation from the computing device, wherein the payment confirmation comprises a verification that funds have been transferred by the computing device from a first account to a second account due to:
scanning, by a mobile device, the symbology to obtain the data; and
submitting, by the mobile device, the data to the remote computing device.

27. The system of claim 26, wherein the firs account is associated with the mobile device.

28. The system of claim 26, wherein the symbology comprises one or more of a multi-dimensional bar code and a quick response (QR) code.

29. The system of claim 26, wherein one or more programming instructions that, when executed, cause the processing device to provide the symbology to the mobile device further comprise one or more programming instructions that, when executed, cause the processing device to affix the symbology to a bill and transmit the bill to the mobile device.

30. The system of claim 26, wherein the data comprises a unique identifier that directs the remote computing device to retrieve the billing information.

31. The system of claim 26, wherein the billing information comprises at least one of payor information, payee information, an amount billed, a minimum amount due, a total balance due, a past due amount, a due date, penalties to be assessed, and interest rates.
